(19) United States
(12) Patent Application Publication
(10) Pub. No.: US 2004/0158488 A1
(43) Pub. Date: Aug. 12, 2004

(54) Internet based automated real estate post card mailout system

(76) Inventor: Kurt D. Johnson, St. Paul, MN (US)

Correspondence Address: Donald W. Meeker, Patent Agent, 924 East Ocean Front #E, Newport Beach, CA, 92661, US

(21) Appl. No.: 10/360,409

(22) Filed: Feb. 7, 2003

(51) Int. Cl. G06F 17/60

(52) U.S. Cl. 705/14

(57) ABSTRACT

A software program related to the real estate industry that is designed to create postcards for advertising purposes. The program allows people (especially Realtors) wanting to sell real estate to go online to the invention web site and input a photo of the house, a photo of the Realtor, and information about the house. The software program of the web site automatically sets up the post cards for printing. The program also sets up the post cards to be printed with names and addresses for mailing the post cards to potential buyers on a mailing list input into the program. The program has the ability to access mailing lists (databases) of potential buyers in different regional areas. The post cards are automatically mailed out. All the user of the program has to do is go to the web site, input credit card information, input the photos and property information, and input the target area for potential customers.

### BACKGROUND OF THE INVENTION

1. Field of the Invention

The present invention relates to software programs designed for the real estate industry, in particular one that can be accessed through a web site, to create postcards for advertising purposes and automatically mailed out to target mailing lists.

2. Description of the Prior Art

Advertising is a major key to selling. In the real estate industry, successful advertising requires that the potential buyers in specific geographical regions be reached and shown one or more photographs of and information about the property being sold. It also helps to personalize the selling process by providing a photograph of the realtor selling the property.

The Internet provides an excellent opportunity for selling real estate and real estate services, but there are still many people who do not use the internet or who do not shop for property on the internet or who might potentially be interested in buying real estate or selling their home, but are not actively looking. In these cases conventional advertising, especially in the form of full color post cards is a highly effective way to advertise real estate. Integrating the Internet and other computer capabilities with conventional advertising is highly desirable. Other prior art attempts to do so have fallen short of the full potential.

Prior art U.S. Pat. No. 5,794,216, issued Aug. 11, 1998 to Brown, provides a device for storing information about a plurality of houses, for access by an application program executed on a computer or other like programmable apparatus, comprises a computer-readable storage medium and computer-readable data on the computer-readable storage medium. The computer-readable data is representative of a database containing textual information for each house, at least one exterior image for each house, at least one interior image for each house, and at least one parameter indicating a portion of the exterior image corresponding to the interior image for each house, all in a common database format. Methods, systems, and articles of manufacture for compiling information about a house on a computer-readable storage medium using a computer are disclosed.

Prior art U.S. Pat. No. 5,235,680, issued Aug. 10, 1993 to Bijnagte, illustrates a system and method for storing, retrieving displaying, printing and otherwise manipulating color images stored in a central “host” computer from a realtor's remote data terminal includes a host computer which stores and maintains a database containing listings of real estate properties on the market. The host computer also optionally can store image information relating to specific properties. Images can be loaded from remote terminals over telephone lines to the host system on an interactive basis. Images can then be retrieved from the host system, also on an interactive basis, for display, printing, or storage on a storage medium associated with the remote display terminals. Images may also be deleted on an interactive basis from a remote terminal. A specific communications protocol conveys image data between the host computer and remote data terminals. This protocol includes specific “time-out” limitations, CRC error checking schemes, and a specific “handshaking” signaling sequence that must be observed before the host system will permit manipulation of image files.

Prior art U.S. Pat. No. 5,146,548, issued Sep. 8, 1992 to Bijnagte, depicts listings of real estate properties, photographed (or videotaped) images that are converted to digital graphics at the “front end” of the publishing process. This image conversion (“capture”) process includes cropping, contrast adjustment using statistical techniques, and generation of control information needed later in the process. A library of digital graphics and associated information is maintained. Graphics selected from this library and a conventional “multiple listing service” text database are then merged during a text composition process to provide a stream of digital data including text and embedded graphics to be printed in the listing book. Because all image operations (e.g., sizing, cropping, and digital image quality enhancement) are performed when the images are captured, no time consuming post processing steps are required. Image capture is performed in a single step, and once an image is captured it can be used “as is” in the printing process without further review, modification or post processing.

Prior art U.S. Pat. No. 4,870,576, issued Sep. 26, 1989 to Tornetta, puts forth a novel system and method for locating real estate properties for potential purchase including a graphical locator interface which permits definition of a desired area for search by placing of a user-controlled selector on a map displayed on a CRT. Additional search qualifications including price, type of structure and others are also specified. The completed specification is then transmitted to a host system and is used for a search of a database of available properties.

Prior art U.S. Pat. No. 5,754,850, issued May 19, 1998 to Janssen, illustrates a method and apparatus that is provided for a search system based in software running on a personal computer. The personal computer is housed in a kiosk having a touch monitor and a printer. With the search system, selection features are selected and a search based upon these search features is performed. Each item in a database is examined to determine if an item has a given search feature. These search features are categorized into primary and non-primary search features. Items neither satisfying nor closely satisfying a given primary search feature are eliminated from the search. In contrast, items not satisfying a given non-primary feature may remain in a search pool. For both primary and non-primary features, if an item in a database is an exact match to a given search feature, then that item is assigned full points. If an item closely satisfies the search feature then that item is assigned full or partial points. After completion of comparing each primary and non-primary search features with each item in the search pool, predetermined number of items remaining in the search pool with the highest total points are displayed to the user of the search system.

Prior art U.S. Pat. No. 5,852,810, issued Dec. 22, 1998 to Sotiroff, shows a geographic-specific information search system and method comprising a World Wide Web home page and associated script files for searching for housing information in a desired geographic region. The system is configured to display a graphical map and to allow the user to narrow the geographic search area to the desired region. The system is also configured to accept a query criteria and search a database containing property listings for properties listed in the desired region meeting the entered search criteria. A geographic map of the desired region including properties found during the search is displayed and the user is allowed to select properties from the map with a pointing device and subsequently view information describing the selected properties.

Prior art U.S. Pat. No. 6,397,208, issued May 28, 2002 to Lee, indicates an on-line interactive, Internet-based real estate service that provides property listings in the context of a set of user selected points-of-interest. The real estate service provides a database of properties and a user sets points-of-interest. The real estate service calculates and displays distances between properties selected from the database and the user set points-of-interest. In this way, the user can search for properties in the context of points of interest.

Prior art U.S. Pat. No. 4,429,385, issued Jan. 31, 1984 to Cichelli, provides a method and apparatus for digital serial scanning with hierarchical and relational access. Digitally encoded data such as classified advertising and other data bases of similarly related messages are broadcast on a serial-type digital data transmission system. Each message is preceded by a headnote, structured so that upon reception, the receiver can select messages based upon a combination of hierarchical and relational views of the message data, without any interaction whatsoever with the broadcast system. “Hierarchical access” means that messages are considered in categories and sub-categories. “Relational access” means that within sub-categories access is possible by a combination of attributes or keywords (i.e. using “and”, “or”, and “not” to combine multiple key phrases). We call the invention ReQueSt-DB. The name is derived from “Relational Queries on Sequential Data Bases”. ReQueSt-DB allows rapid and facile access to one-way, cyclically broadcast, bit serial, sequential data bases consisting of (possibly) many thousands of messages with high selectivity. In the content of a particular broadcast data base (i.e. one in which part of the data base is classified advertising), a ReQueSt-DB query might be the logical equivalent of “Show me on my television screen the set of classified, real estate ads which describe houses for sale in the Lehigh Valley, Pa., which are in either Allentown or Bethlehem but not in Easton, and that have 3 or more bedrooms and have central air conditioning and may or may not have a family room and are priced between $60,000 and $100,000”.

Prior art U.S. Pat. No. 5,032,989, issued Jul. 16, 1991 to Tometta, illustrates a method for locating available real estate properties for sale, lease or rental using a database of available properties at a central location and remote stations which use a graphic interface to select desired regions on a map of the areas in interest. The user begins with a region where they are interested in acquiring property and select an inner area within this region by using a pointing device such as a mouse to designate boundaries on a map displayed on screen. This is then zoomed in on and a second area is selected within the zoomed region. The second area is then cross-referenced with the database of available properties whose approximate locations are then pictorially displayed on screen. Information about the properties can then be obtained in textual form.

Prior art U.S. Patent application #20020054331, issued May 9, 2002 to Takenobu, shows a method and system to send a card with a photograph able to remotely create a post-card, with a photo taken by a sender, and send the postcard to any destination regardless of who is to receive it. In particular, this invention discloses a method by which a customer can use a photo terminal having a communication capacity connected via a computer network to the computer system at a print shop to request that the print shop remotely creates and sends a card with a photo on it. The image to be printed on the card and the text data, including the name and address of the recipient and the name of the sender, are transmitted from the photo terminal to the computer network, and the customer requests that the print shop remotely creates and sends the card. The computer system at the print shop receives the image and text sent via the computer network, and the order to print remotely and send the postcard. The system prints the image and the specific text data it has received on a card to create a picture postcard, which it then sends.

Prior art U.S. Pat. No. 5,555,496, issued Sep. 10, 1996 to Tackbary, claims a system for communicating with a card distribution center for selecting, ordering, and sending social expression cards using a personal computer. The user can enter names and addresses of card recipients into the system wherein the information is maintained in a database. The system displays digitized images of the cards on a display screen which are retrieved from a card database. From the cards displayed, the user can select cards for designated recipients and enter personalized messages and a digitized signature. The user may then send the order to a card distribution center, which processes the order, retrieves and prints the selected card images, including any user messages or user signature, and mails the cards to designated recipients or customers. The system maintains a database of all recipients, addresses, associated occasions and dates, card preferences, relationships and order history.

Prior art U.S. Pat. No. 6,092,054, issued Jul. 18, 2000 to Tackbary, describes a system for communicating with a card distribution center for selecting, ordering, and sending social expression cards using a personal computer. The user can enter names and addresses of card recipients into the system wherein the information is maintained in a database. The system displays digitized images of the cards on a display screen which are retrieved from a card database. From the cards displayed, the user can select cards for designated recipients and enter personalized messages and a digitized signature. The user may then send the order to a card distribution center, which processes the order, retrieves and prints the selected card images, including any user messages or user signature, and mails the cards to designated recipients or customers. The system maintains a database of all recipients, addresses, associated occasions and dates, card preferences, relationships and order history.

Prior art U.S. Pat. No. 5,960,412, issued Sep. 28, 1999 to Tackbary, discloses a system for communicating with a card distribution center for selecting, ordering, and sending social expression cards using a personal computer. The user can enter names and addresses of card recipients into the system wherein the information is maintained in a database. The system displays digitized images of the cards on a display screen which are retrieved from a card database. From the cards displayed, the user can select cards for designated recipients and enter personalized messages and a digitized signature. The user may then send the order to a card distribution center, which processes the order, retrieves and prints the selected card images, including any user messages or user signature, and mails the cards to designated recipients or customers. The system maintains a database of all recipients, addresses, associated occasions and dates, card preferences, relationships and order history.

Prior art U.S. Pat. No. 6,301,607, issued Oct. 9, 2001 to Barraclough, depicts an invention that provides methods and arrangements for using the Internet and an Internet access appliance to share images, wherein the images are captured, downloaded, and sent to a server. At the server, the images are parsed and posted to a web page. Subsequent communication is automatically sent to individuals selected by the sender to notify them of the posting of new images. The present invention provides an effective and efficient manner in which to share images for business, marketing, and home use.

Prior art U.S. Pat. No. 6,167,469, issued Dec. 26, 2000 to Safai, puts forth a method and apparatus for transporting digital images. In one embodiment, a personal electronic hand held digital camera executes an application program that enables a user of the camera to send one or more digital images, formed by and stored in the camera, from the camera to a destination. One or more addresses describing one or more destinations are selected or identified. One or more stored digital images are selected and associated with the one or more addresses. Optionally, a voice message is recorded and associated with the one or more addresses. The camera is coupled to a data communication network, and a transport operation is initiated. Under control of the application, the camera sends the selected images to the designated destinations over the data communication network. When an address is a physical address, for example, a postal mail address, the selected images are automatically routed to a central server. At the central server, tangible copies of the selected images are printed, packaged, and sent to the physical address. Each image may be marked with an authentication stamp that uniquely identifies the image or the camera that created the image, guarding against unauthorized alteration.

What is needed is a data base system that is linked to a web site, which a realtor can access to create a postcard for advertising purposes.

### SUMMARY OF THE INVENTION

An object of the present invention is to provide a data base system that is linked to a web site, which a Realtor can access to create a postcard for advertising purposes. One more object of the present invention is to allow for direct selling, instead of relying on Internet marketing or viral marketing to attract new customers. An additional object of the present invention is to allow people (especially Realtors) wanting to sell real estate to go online to the invention web site and input a photo of the house, a photo of the Realtor, and information about the house.

A further object of the present invention is that the software program of the web site automatically sets up the post cards for printing. A contributory object of the present invention is to provide a program that also sets up the post cards to be printed with names and addresses for mailing the post cards to potential buyers on a mailing list input into the program.

An added object of the present invention is to provide a program that has the ability to access mailing lists (databases) of potential buyers in different regional areas.

An ensuing object of the present invention is to provide a system in which the post cards are automatically mailed out.

Yet another object of the present invention is to provide an easy to use program. The user of the program just simply goes to the web site, inputs credit card information, the photos, property information, and the target area for potential customers.

In brief, this invention allows people (especially Realtors) wanting to sell real estate to go online to the invention web site and input a photo of the house, a photo of the Realtor, and information about the house. The software program of the web site automatically sets up the post cards for printing. Initially the file will be sent to a printer, but it could be directly connected to a printer. The program also sets up the post cards to be printed with names and addresses for mailing the post cards to potential buyers on a mailing list input into the program. The program has the ability to access mailing lists (databases) of potential buyers in different regional areas. The post cards are automatically mailed out. All the user of the program has to do is go to the web site, input credit card information, input the photos and property information, and input the target area for potential customers.

Another advantage of the present invention is that it allows for direct selling, instead of relying on Internet marketing or viral marketing to attract new customers.

An additional advantage of the present invention is to allow people (especially Realtors) wanting to sell real estate or attract new home sellers to go online to the invention web site and input a photo of the house, a photo of the Realtor, and information about the house.

A further advantage of the present invention is that the software program of the web site automatically sets up the post cards for printing. Yet another advantage of the present invention is to provide a program that also sets up the post cards to be printed with names and addresses for mailing the post cards to potential buyers on a mailing list input into the program.

An added advantage of the present invention is in providing a program that has the ability to access mailing lists (databases) of potential buyers in different regional areas.

Still another advantage of the present invention is that it provides a system in which the post cards are automatically mailed out.

One more advantage of the present invention is in providing an easy to use program. The user of the program just simply goes to the web site, inputs credit card information, the photos, property information, and the target area for potential customers.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view of the system and web site development;

FIG. 2 is a diagrammatic view of the POSTCARD BUILDER™ format;

FIG. 3 is a diagrammatic view of the input to the front and back of the postcard.

### BEST MODE FOR CARRYING OUT THE INVENTION

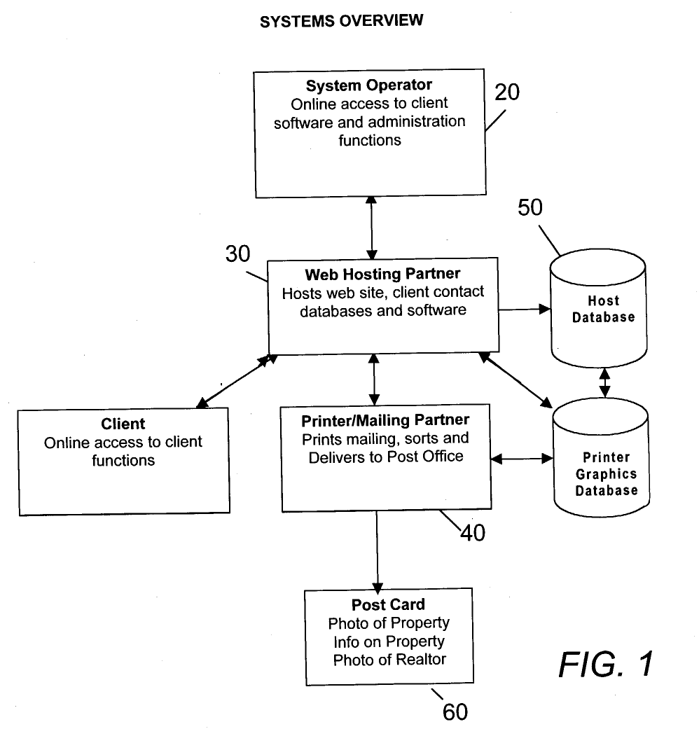

In FIG. 1, a software program 20 allows a Realtor or other user to go online to the invention web site 30 and input their credit card information, a photo of the house, a photo of the Realtor, information about the house, and the target area for potential customers. The software program 20 of the web site 30 would automatically set up post cards 60 for printing. Initially the file will be sent to a printer 40, but could alternately be directly connected to a printer 40. The program 20 also sets up the post cards 60 to be printed with names and addresses for mailing the post cards 60 to potential buyers on a mailing list 50 input into the program 20. The program 20 has the ability to access mailing 50 (databases) of potential buyers in different regional areas. The post cards 60 may be automatically mailed out by a mailing means accessible by the software program.

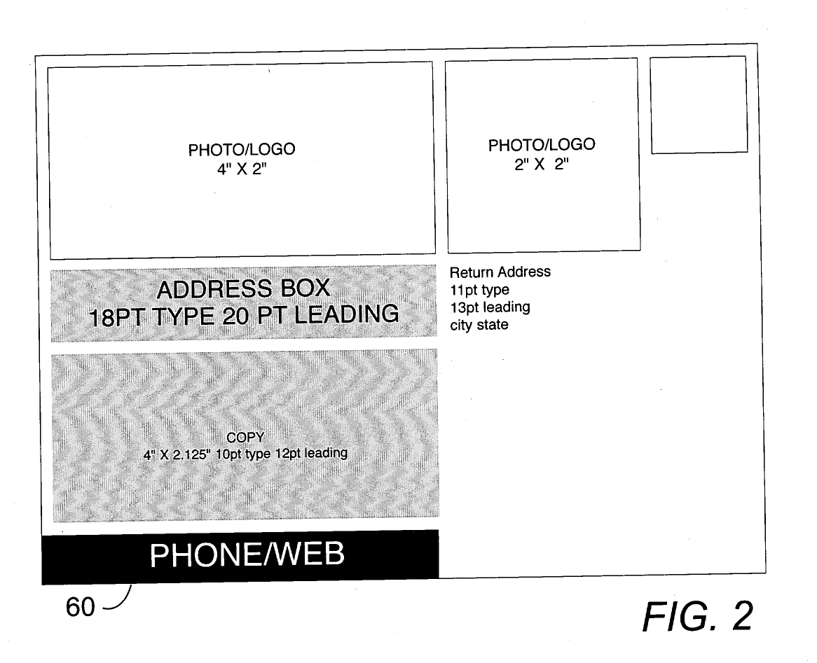

In FIG. 2, a flow chart of the POSTCARD BUILDER™ instructions is depicted in which the Realtor would choose a format, design cover, design back and mailing list, and then view and run the mailing.

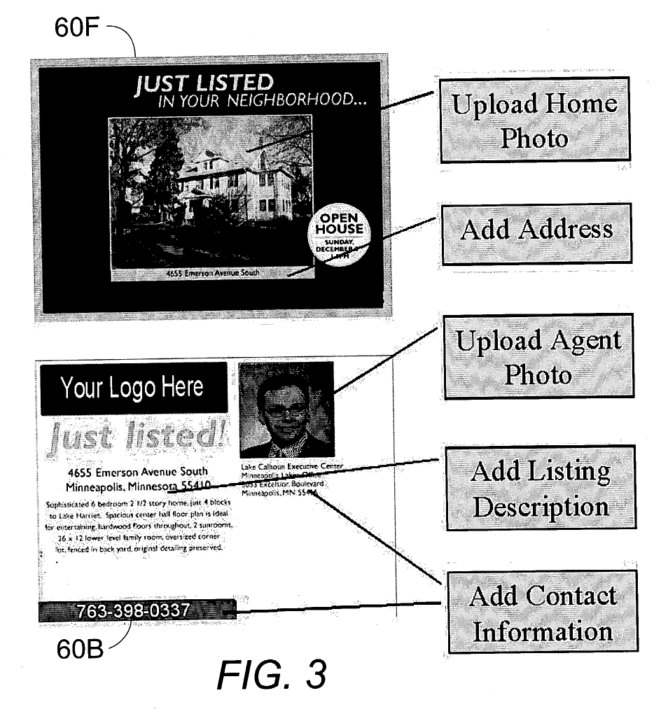

In FIG. 3, the input information is shown for the postcard front 60F and back 60B.

In practice, a person (Realtor or other user) would go online to the invention web site 30 and input their credit card information, a photo of the house, a photo of the Realtor or other user, information about the house, and the target area for potential customers. The software program 20 of the web site 30 would automatically set up the post cards 60 for printing. Initially the file will be sent to a printer 40, but could alternately be directly connected to a printer 40. The program 20 also sets up the post cards 60 to be printed with names and addresses for mailing the post cards to potential buyers on a mailing list 50 input into the program 20. The program 20 has the ability to access mailing lists 50 (databases) of potential buyers in different regional areas. The post cards 60 are automatically mailed out.

It is understood that the preceding description is given merely by way of illustration and not in limitation of the invention and that various modifications may be made thereto without departing from the spirit of the invention as claimed.

1. What is claimed is:
a system for automated mail advertisement of real estate via the internet, the system comprising:
a software program related to the real estate industry on a computerized server on a computer network, the software program capable of receiving descriptive information about at least one real estate property and at least one photograph of the property input by a user via at least one web site on the computerized network related to the real estate industry, the software program further capable of automatically setting up at least one post card format for printing a number of the post cards with the information and at least one photograph for advertising purposes, the software program further capable of accessing at least one data base of names and addresses of potential buyers of the at least one property and further capable of setting up for printing at least one mailing list of the names and addresses of the prospective buyers.

2. The system of claim 1 wherein the at least one photograph comprises at least one photograph of the at least one real estate property and at least one photograph of a seller of the property.

3. The system of claim 1 wherein the software program is further capable of automatically printing the post cards on a printing means accessible by the software program.

4. The system of claim 3 wherein the software program is further capable of automatically mailing the post cards via a mailing means accessible by the software program.

5. The system of claim 1 wherein the at least one data base comprises at least one targeted list of potential buyers in a specific geographical area associated with the at least one property and the software program is capable of automatically seeking out the mailing list of potential buyers based on the information about the property.

6. The system of claim 1 wherein the at least one data base comprises at least one targeted list of potential buyers in a specific geographical area associated with the at least one property and the geographical location of the potential buyers on the mailing list is input by the user.
